(19) United States
(12) Patent Application Publication
(10) Pub. No.: US 2009/0151452 A1
(43) Pub. Date: Jun. 18, 2009

(54) Method and Device for Determining a Rate of Rotation

(76) Inventors: Raphael Mayer-Wegelin, Friedrichsdorf (DE); Heinz-Werner Morell, Kaiserslautern (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/991,700

(22) PCT Filed: Aug. 24, 2006
(86) PCT No.: PCT/EP2006/065618

§ 371 Date: Mar. 7, 2008

(30) Foreign Application Priority Data
Sep. 9, 2005 (DE) 102005043025.2

(51) Int. Cl. G01C 19/56

(52) U.S. Cl. 73/504.12

(57) ABSTRACT

The invention relates to a method for determining a rate of rotation, in which, as a function of a primary actuating signal (E_PRIM), a sensor element (2), the natural frequency (FE) of which is linearly dependent on its temperature (T), is excited so as to perform a primary oscillation along a first axis (AXIS_{—}1). A primary measurement signal (A_PRIM), which is representative of the primary oscillation, is determined. Also, a secondary measurement signal (A_SEC) is determined which is representative of a secondary oscillation of the sensor element (2) along a second axis (AXIS_{—}2), which together with the first axis (AXIS_{—}1) encloses an angle that is unequal to zero. The natural frequency (FE) of the sensor element (2) is determined. On the basis of the determined natural frequency (FE) only, at least one value is adjusted which affects the primary actuating signal (E_PRIM) and/or at least one other actuating signal. The rate of rotation (N) is determined as a function of an amplitude and/or a phase of the secondary output signal (A_SEC). In addition, a rate of rotation corrective value (E6, E7), which affects the determination of the rate of rotation (N), can be adjusted as a function of the temperature (T).

The invention relates to a method and to a corresponding apparatus for determining a rotation rate. The rotation rate is determined by means of a rotation rate sensor. The rotation rate sensor comprises a body which can oscillate. The body which can oscillate is energized to carry out a primary oscillation. Rotation of the rotation rate sensor results in a secondary oscillation of the body which can oscillate, which secondary oscillation is superimposed on the primary oscillation. The rotation rate at which the rotation rate sensor is rotated can be determined as a function of the secondary oscillation.

DE 198 32 906 C1 discloses a capacitive rotation rate sensor. The rotation rate sensor comprises a seismic mass which is mounted in a sprung manner and is designed to be mirror-image symmetrical. Electrodes and at least two groups of comb-like opposing electrodes, which are arranged with mirror-image symmetry, are attached like a comb to the mass. The opposing electrodes are each attached to a mount and act between the electrodes which are attached to the seismic mass. The mount for the opposing electrodes is mounted on a ceramic mount just in the area of those points which are located closest to the axis of symmetry.

WO 95/16921 discloses a rotation rate sensor in which a temperature sensor for temperature compensation is arranged in the rotation rate sensor or in the vicinity of the rotation rate sensor.

DE 691 13 597 T2 discloses a method for determining the scaling factor of a piezoelectric rotation rate sensor for the purpose of scaling factor compensation, having the following steps. A vibration device is activated such that the vibration of a structure which can vibrate is energized at a primary driver point by this. The vibration magnitude at the primary tapping off point on the structure is monitored. The magnitude of the vibration at the primary tapping off point is compared with a reference value, and the magnitude of the vibration at the primary driver point is varied in order to keep the magnitude of the vibration at the primary tapping off point essentially constant. Furthermore, a natural resonant frequency of the structure which can vibrate is measured. The driver current amplitude and the driver voltage amplitude downstream from the vibration device are monitored at resonance. A power input downstream from the structure which can vibrate is determined at resonance from the monitored driver current amplitude and the driver voltage amplitude at the natural resonant frequency. The Q-factor of the vibration structure is determined at resonance, using the power input. The piezoelectric charge coefficient of the vibration structure is determined. The scaling factor is determined using the Q-factor and the piezoelectric charge coefficient. The magnitude of a secondary vibration mode is measured, and the scaling factor and the magnitude of the secondary vibration mode are used in order to determine the rotation rate of the sensor.

The object of the invention is to provide a method and an apparatus for determining a rotation rate, which method and apparatus allow the rotation rate to be determined easily and precisely.

The object is achieved by the features of the independent claims. Advantageous refinements of the inventions are characterized in the dependent claims.

The invention is distinguished by a method for determining a rotation rate. The invention is also distinguished by an apparatus for carrying out the method for determining the rotation rate. A primary actuating signal energizes a sensor element, whose natural frequency is linearly dependent on its temperature, to carry out a primary oscillation along a first axis. A primary measurement signal which is representative of the primary oscillation is recorded. Furthermore, a secondary measurement signal is recorded, which is representative of a secondary oscillation of the sensor element along a second axis which includes an angle which is not equal to zero with the first axis. The natural frequency of the sensor element is determined. At least one value which acts on the primary actuating signal and/or at least one further actuating signal is adapted as a function of the determined natural frequency. The rotation rate is determined as a function of the amplitude and/or the phase of the secondary output signal.

The oscillation response of the body which can oscillate may vary when the temperature of the rotation rate sensor changes. The change in temperature can also affect the determination of the rotation rate. If a change in the temperature of the sensor element and/or of a control apparatus, which is designed to determine the rotation rate using the sensor element, affects the primary actuating signal and/or at least one further actuating signal, then the adaptation of the value which acts on the primary actuation signal and/or at least one further actuating signal simply contributes to compensation for the effect of the change in the temperature, and therefore allows the rotation rate to be determined easily and precisely. The adaptation is preferably carried out just as a function of the natural frequency.

In one advantageous refinement of the method, the temperature of the sensor element is determined as a function of the natural frequency. This allows the temperature of the sensor element to be determined. The sensor element can then be used to determine temperature in a rotation rate sensor and/or the control apparatus. Furthermore, the rotation rate sensor can then be used as a temperature sensor.

In a further advantageous refinement of the method, the value which acts on the primary actuating signal and/or at least one further actuating signal is determined by means of a mathematical development of the value about a reference frequency of the sensor element. The reference frequency of the sensor element is representative of the natural frequency of the sensor element at a reference temperature. By way of example, the mathematical development may be a Taylor development. However, it is also possible to use some other suitable mathematical development. A mathematical development such as this can easily contribute to simple compensation for the effect of the change in temperature.

In a further advantageous refinement of the invention, the value comprises a nominal value for the amplitude of the primary measurement signal. However, the value may also comprise a first phase angle, from which demodulation is carried out as a function of the real part and/or the imaginary part of the secondary output signal. However, the value may also comprise a second phase angle, from which modulation is carried out as a function of the real part and/or the imaginary part of the secondary output signal. However, the value may also comprise a first manipulated variable correction value and/or a second manipulated variable correction value, from which adaptation is carried out as a function of a value of the real part and/or the imaginary part of the secondary output signal.

This allows temperature compensation to be carried out specifically at different points in a control loop for the rotation rate sensor, providing a simple means for contributing to determining the rotation rate particularly precisely.

Furthermore, the invention is distinguished by a method and an apparatus for determining the rotation rate, in which at least one rotation rate correction value which acts on the rotation rate is adapted just as a function of the determined natural frequency. This correction value does not affect a manipulated variable. It can be used to correct for just a known system-dependent discrepancy between the determined rotation rate and the actual rotation rate, providing a simple means for contributing to determining the rotation rate particularly precisely.

In this context, it is advantageous for the rotation rate correction value which acts on the rotation rate to be determined by means of a mathematical development of the rotation rate correction value about the reference frequency of the sensor element, which reference frequency is representative of the natural frequency of the sensor element at the reference temperature. This provides a particularly simple means for contributing to compensation for the effect of the change in the temperature of the rotation rate sensor.

In one advantageous refinement of the apparatus, the apparatus has a control apparatus which is arranged at a predetermined distance from the sensor element. The control apparatus is designed to determine its own temperature as a function of the temperature of the sensor element and to determine the rotation rate as a function of its own temperature. If the sensor element is arranged sufficiently close to the control apparatus, then the sensor element can determine the temperature of the control apparatus. The internal processes in the control apparatus can then be adapted as a function of the temperature. This allows the rotation rate to be determined extremely precisely.

Exemplary embodiments of the invention will be explained in more detail in the following text with reference to the schematic drawings, in which:

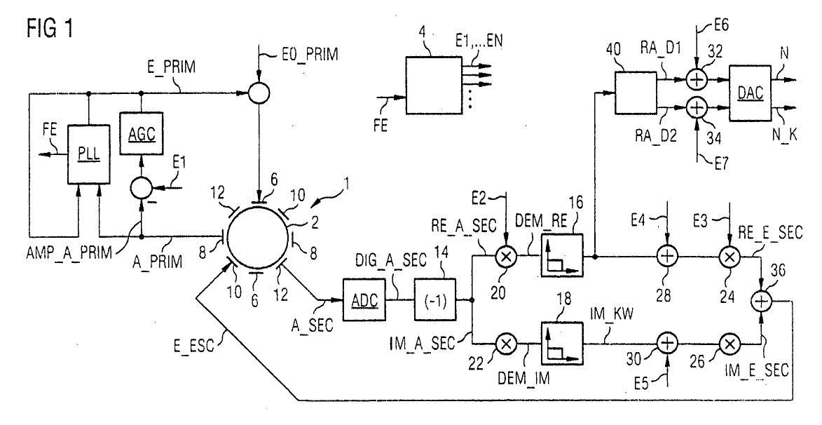

FIG. 1 shows a block diagram of an apparatus for determining a rotation rate, and a schematic illustration of a rotation rate sensor;

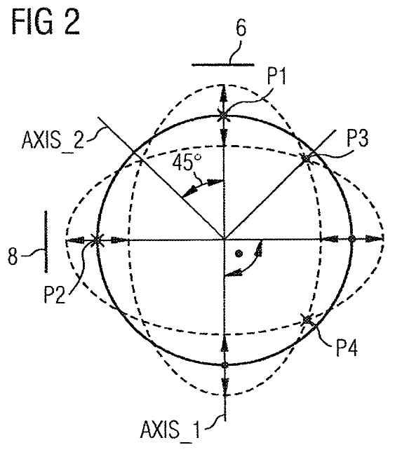

FIG. 2 shows an outline sketch of a primary oscillation of a sensor element;

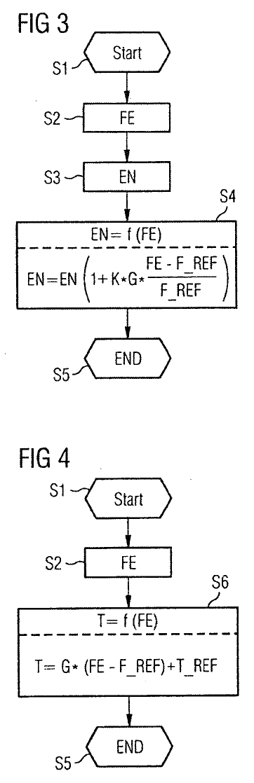

FIG. 3 shows a flowchart of a program for adaptation of a value; and

FIG. 4 shows a flowchart of a program for determining a temperature.

Elements of the same design or having the same function are identified by the same reference symbols throughout all the figures.

A rotation rate sensor 1 (FIG. 1) preferably has a sensor element 2, which is preferably formed from a ring. The natural frequency FE of the sensor element 2 is linearly dependent on the temperature T of the sensor element 2. Furthermore, the rotation rate sensor 1 has at least one, preferably two, primary energizer electrodes 6, primary detector electrodes 8, secondary energizer electrodes 10 and secondary detector electrodes 12. If the rotation rate sensor 1 is rotated at a rotation rate N, then the rotation rate sensor 1 is suitable for determining the rotation rate N.

A primary control loop preferably comprises the primary energizer electrodes 6, the primary detector electrodes 8, automatic gain control AGC and a phase locked loop PLL. A secondary control loop preferably comprises the secondary energizer electrodes 10, the secondary detector electrodes 12, an analog/digital converter ADC, an inverter 14, a first and a second demodulator 20, 22, a first and a second modulator 24, 26 and a first and a second compensation point 28, 30, as well as an addition point 36. Furthermore, a calculator 40, a first and a second correction point 32, 34 and a digital/analog converter DAC preferably contribute to determining the rotation rate N.

The sensor element 2 is caused to carry out the primary oscillation and a primary measurement signal A_PRIM is recorded as a function of a primary start actuating signal E0_prim. The primary start actuating signal E0_prim is preferably an alternating voltage which is applied to the primary energizer electrodes 6. The rotation rate sensor 1 is preferably designed such that the sensor element 2 oscillates at its natural frequency FE when the rotation rate N has been determined. The natural frequency FE of the sensor element 2 is, however, linearly dependent on the temperature T of the sensor element 2. The frequency of the primary start signal E0_PRIM is therefore first of all varied within a predetermined frequency interval until the amplitude AMP_A_PRIM of the primary measurement signal A_PRIM reaches a predetermined start threshold value, which is representative of the amplitude of the primary oscillation at the natural frequency FE.

The phase locked loop PLL preferably has a voltage controlled oscillator. The coupling of the phase locked loop PLL in the primary control loop contributes to the sensor element 2 always oscillating approximately at its temperature-dependent natural frequency FE. The automatic gain control contributes to monitoring of the amplitude of the primary oscillation. For this purpose, the amplitude AMP_A_PRIM of the primary measurement signal A_PRIM is regulated at a nominal value E1. The nominal value E1 of the amplitude AMP_A_PRIM of the primary measurement signal A_PRIM is preferably determined on a test rig and is adapted as a function of the temperature T by a control apparatus 4 during operation of the rotation rate sensor 1.

Because the sensor element 2 is in the form of a ring, the primary oscillation of the sensor element 2 along a first axis AXIS_1 (FIG. 2) results in a corresponding oscillation along an axis which corresponds to the first axis AXIS_1 that is at right angles to the first axis Axis_1. To a first approximation, the amplitude of the primary oscillation is therefore a maximum at a primary energizing point P1 and at a primary tapping off point P2. This contributes to the primary detector electrode 8 being able to record the primary measurement signal A_PRIM very precisely. A second axis AXIS_2 includes an angle of 45° with the first axis AXIS_1. Oscillation nodes of the sensor element 2 are formed at a secondary energizer point P3 and at a secondary tapping off point P4, which points are located on the second axis AXIS_2, at which oscillation nodes the amplitude of the primary oscillation along the second axis AXIS_2 is zero in the case of an ideal sensor element 2.

When the rotation rate sensor 1 is rotated at the rotation rate N, then a secondary oscillation is superimposed on the primary oscillation. The secondary oscillation causes an oscillation with an amplitude along an undefined axis which includes an angle which is not equal to zero with the first axis AXIS_1. The secondary oscillation as well as the oscillation along the undefined axis are representative of the rotation rate N.

The secondary oscillation is preferably recorded along the second axis AXIS_2 at the secondary tapping off point P4 by the secondary detector electrodes 12. The secondary detector electrodes 12 detect a secondary measurement signal A_SEC. The secondary measurement signal A_SEC is representative of the secondary oscillation, and is modulated with the rotation rate N. The secondary measurement signal A_SEC is preferably converted by the analog/digital converter ADC to a digital secondary measurement signal A_SEC_DIG. The analog/digital converter ADC is preferably followed by an inverter 14 which inverts the digitized secondary measurement signal DIG_A_SEC. The inversion results in the secondary measurement signal A_SEC being fed back and contributes to a secondary actuating signal E_SEC being created causing the secondary oscillation to be counteracted at the secondary energizer electrodes 10.

After inversion, a real part RE_A_SEC and an imaginary part IM_A_SEC of the digitized secondary measurement signal DIG_A_SEC can be demodulated separately from one another. The real part RE_A_SEC is representative of an amplitude AMP_A_SEC of the secondary measurement signal A_SEC, and is therefore also representative of the secondary oscillation and the rotation rate N. The real part RE_A_SEC is demodulated by a first demodulator 20 such that the rotation rate N can be determined from a demodulated real part DEM_RE of the digital secondary measurement signal A_SEC. The demodulation is preferably carried out as a function of a first phase angle E2, which can be determined on the test rig at a reference temperature REF_T and can be adapted, preferably as a function of the temperature T, by the control apparatus 4 during operation of the rotation rate sensor 1. A rotation rate value by means of which the rotation rate N can be determined is produced in a first filter arrangement 16 from the demodulated real part DEM_RE of the secondary measurement signal A_SEC. A first digital value RA_D1 of the rotation rate N and a second digital value RA_D2 of the rotation rate N are determined as a function of the rotation rate value by the calculator 40. The two different digital values RA_D1, RA_D2, contribute to mutual plausibility between them. Any system-dependent error in the first digital value RA_D1 and/or in the second digital value RA_D2 can be corrected at the first correction point 32 and at the second correction point 34 as a function of a respective first and second rotation rate correction value E6, E7. The first and the second rotation rate correction values E6, E7 can preferably be determined on the test rig at a reference temperature REF_T, and can be adapted as a function of the temperature T during operation of the rotation rate sensor 1. After correction, the rotation rate N and a corresponding rotation rate N_K for plausibility are determined from the digital values RA_D1, RA_D2. The demodulated real part DEM_RE can be adapted, corresponding to a first manipulated variable correction value E4 at the first compensation apparatus 28. The adaptation of the demodulated real part DEM_RE affects the secondary actuating signal E_SEC and contributes to counteracting the secondary oscillation. The first manipulated variable correction value E4 can preferably be determined on the test rig and can be adapted as a function of the temperature T by the control apparatus 4 during operation of the rotation rate sensor 1. The demodulated real part DEM_RE can be modulated in the first modulator 24 as a function of a second phase angle E3. The second phase angle E3 can preferably be determined on the test rig at a reference temperature T_REF, and can be adapted as a function of the temperature T by the control apparatus 4 during operation of the rotation rate sensor 1. A real part RE_E_SEC of the secondary actuating signal E_SEC is produced by modulation of the demodulated real part DEM_RE.

The imaginary part IM_A_SEC of the secondary measurement signal A_SEC is representative of the phase and the frequency of the secondary measurement signal A_SEC. The imaginary part IM_A_SEC can be demodulated by a second demodulator 22. The demodulation is carried out as a function of the first phase angle E2, since the imaginary part IM_A_SEC is always shifted in phase through 90° with respect to the real part RE_A_SEC. Alternatively, the first phase angle E2 may also directly affect the imaginary part IM_A_SEC, and the phase shift of 90° with respect to the imaginary part IM_A_SEC is then taken into account during the demodulation of the real part RE_A_SEC. The second filter arrangement 18 produces a monitoring value IM_KW as a function of the imaginary part IM_A_SEC. The monitoring value IM_KW is precisely zero when using an ideal rotation rate sensor 1 and when the rotation rate N is zero. A real rotation rate sensor 1 has a monitoring value IM_KW that is not equal to zero, however, and is representative of the offset of the rotation rate sensor 1. The monitoring value IM_KW can thus contribute to compensation for the system-dependent offset. For this purpose, the monitoring value IM_KW is adapted as a function of a second manipulated variable correction value E5 at the second compensation point 30. The second manipulated variable correction value E5 can preferably be determined on the test rig at the reference temperature T_REF, and can be adapted as a function of the temperature T by the control apparatus 4 during operation of the rotation rate sensor 1. The adapted monitoring value IM_KW can be modulated by the second modulator 26 as a function of the second phase angle E3. The modulation of the adapted monitoring value IM_KW results in an imaginary part IM_E_SEC of the secondary actuating signal E_SEC.

The real part RE_E_SEC and the imaginary part IM_E_SEC of the secondary actuating signal E_SEC are added at the addition point 36 and therefore form the secondary actuating signal E_SEC, which counteracts the secondary oscillation.

The values EN may, for example, comprise the nominal value E1 of the amplitude of the primary measurement signal A_PRIM and/or the first and/or the second phase angle E2, E3 and/or the first and/or the second manipulated variable correction value E4, E5 and/or the first and/or the second rotation rate correction value E6, E7. The values EN can be adapted as a function of the temperature T by the control apparatus 4. The control apparatus 4 can also adapt the values EN as a function of the natural frequency FE of the sensor element 2, since the natural frequency FE of the sensor element 2 varies linearly with the temperature T. The natural frequency FE can preferably be determined as a function of the primary measurement signal A_PRIM. Alternatively, the natural frequency can also be determined as a function of the secondary measurement signal A_SEC.

A first program for adaptation of the values EN is preferably stored in the control apparatus 4. The first program is preferably started in a step S1 as soon as the sensor element 2 is oscillating approximately at its natural frequency FE.

The natural frequency FE of the sensor element 2 is recorded in a step S2.

One of the values EN determined on the test rig is called up in a step S3.

The value EN that has been called up is adapted as a function of the natural frequency FE in a step S4, preferably using the first calculation rule, which is specified in step S4. The calculation includes a first and a second proportionality factor G, K. The first calculation rule is a Taylor development about the natural frequency FE, terminated after the second term. However, it is also possible to use some suitable other mathematical development and/or a first characteristic for adaptation of the values EN. The first characteristic may, for example, be determined on the test rig and may be stored in the control apparatus 4.

The first program is ended in a step S5. The first program is preferably carried out repeatedly in a loop during operation of the rotation rate sensor 1.

A second program for determining the temperature can also be stored in the control apparatus 4. The second program is preferably started, in a step S1, once the sensor element 2 has reached its natural frequency FE.

The natural frequency FE of the sensor element 2 is recorded in a step S2.

The temperature T is determined as a function of the natural frequency FE in a step S6, preferably using the calculation rule specified in step S6. The second calculation rule is a Taylor development about the natural frequency FE, terminated after the second term. However, it is also possible to use any suitable other mathematical development and/or a second characteristic to determine the temperature T. By way of example, the second characteristic may be determined on the test rig and may be stored in the control apparatus 4.

The invention is not restricted to the described exemplary embodiment. For example, any given value which acts directly and/or indirectly on any given manipulated variable and/or the determined rotation rate can be adapted for any given rotation rate sensor by means of the first program and/or as a function of the result of the second program. Furthermore, the rotation rate sensor 1 may have a greater or lesser number of energizer electrodes and detector electrodes. In a corresponding manner, a greater or lesser number of values which act on the manipulated variables can then be adapted. The automatic gain control AGC, the phase locked loop PLL, the analog/digital converter ADC, the inverter 14, the first and/or the second demodulator 20, 22, the first and/or the second modulator 24, 26 and/or the first and/or the second compensation point 28, 30, the calculator 40 and/or the first and/or the second correction point 32, 34 and/or the digital/analog converter DAC may be either in the form of electronic components or further software programs, which are preferably stored and processed in the control apparatus 4. Furthermore, a greater or lesser number of electronic components may be arranged, and/or corresponding software programs may be stored.

1.-9. (canceled)

10. A method for determining a rotation rate, comprising the steps of:
energizing a sensor element with a primary actuating signal to effect a primary oscillation along a first axis of the sensor element, a natural frequency of the sensor element being linearly dependent on a temperature of the sensor element;
recording a primary measurement signal which is representative of the primary oscillation;
recording a secondary measurement signal which is representative of a secondary oscillation of the sensor element along a second axis of the sensor element, the second axis disposed at an angle relative to the first axis that is not equal to zero;
determining the natural frequency of the sensor element;
determining the rotation rate of the sensor element as a function of at least one of the amplitude and phase of the secondary measurement signal;
adapting at least one rotation rate correction value, which acts on the determined rotation rate, as a function of the determined natural frequency.

11. The method of claim 10, the step of adapting the at least one rotation rate correction value comprises determining the at least one rotation rate correction value using a mathematical development of the at least one rotation rate correction value about a reference frequency of the sensor element, the reference frequency being representative of the natural frequency of the sensor element at a reference temperature.

12. An apparatus for determining a rotation rate of a sensor element, comprising:
a sensor element having a natural frequency linearly dependent on a temperature of the sensor element;
a primary control loop applying a primary actuating signal to the sensor element to effect a primary oscillation of the sensor element along a first axis as a function of the primary actuating signal, the primary control loop configured to record a primary measurement signal representative of the primary oscillation; and
a secondary control loop configured to record a secondary measurement signal representative of a secondary oscillation of the sensor element along a second axis of the sensor element, the second axis disposed at an angle relative to the first axis that is not equal to zero, determine the natural frequency of the sensor element, determine the rotation rate of the sensor element as a function at least one of amplitude and phase of the secondary oscillation, and adapt at least one rotation rate correction value, which acts on the determined rotation rate, as a function of the determined natural frequency.

13. The apparatus of claim 12, further comprising a control apparatus arranged at a predetermined distance from the sensor element, the control apparatus configured to determine a temperature as a function of the temperature of the sensor element, and determine the rotation as a function of the temperature of the control apparatus.

14. A method for determining a rotation rate, comprising the steps of:
energizing a sensor element with a primary actuating signal to effect a primary oscillation along a first axis of the sensor element, a natural frequency of the sensor element being linearly dependent on a temperature of the sensor element;
recording a primary measurement signal which is representative of the primary oscillation;
recording a secondary measurement signal which is representative of a secondary oscillation of the sensor element along a second axis of the sensor element, the second axis disposed at an angle relative to the first axis that is not equal to zero;
determining the natural frequency of the sensor element;
adapting at least one of a value acting on the primary actuating signal or another actuating signal as a function of the determined natural frequency;
determining the rotation rate of the sensor element as a function of at least one of the amplitude and phase of the secondary measurement signal.

15. The method of claim 14, further comprising determining the temperature of the sensor element as a function of the determined natural frequency.

16. The method of claim 14, wherein the step of adapting the at least value comprises determining the value using a mathematical development of the value about a reference frequency of the sensor element, the reference frequency being representative of the natural frequency of the sensor element at a reference temperature.

17. The method of claim 16, wherein the value comprises at least one of:
a nominal value of an amplitude of the primary measurement signal;
a first phase angle used for demodulating a real part or imaginary part of the secondary measurement signal;
a second phase angle used for modulating the real part or imaginary part of the secondary measurement signal; and
a manipulated variable correction value as a function of the real part or imaginary part of the secondary measurement signal.

18. An apparatus for determining a rotation rate of a sensor element, comprising:
a sensor element having a natural frequency linearly dependent on a temperature of the sensor element;
a primary control loop applying a primary actuating signal to the sensor element to effect a primary oscillation of the sensor element along a first axis as a function of the primary actuating signal, the primary control loop configured to record a primary measurement signal representative of the primary oscillation; and
a secondary control loop configured to record a secondary measurement signal representative of a secondary oscillation of the sensor element along a second axis of the sensor element, the second axis disposed at an angle relative to the first axis that is not equal to zero, determine the natural frequency of the sensor element, determine the rotation rate of the sensor element as a function at least one of amplitude and phase of the secondary oscillation, and adapt at least one value, which acts on one of the primary actuation signal or a further actuation signal, as a function of the determined natural frequency.

19. The apparatus of claim 18, further comprising a control apparatus arranged at a predetermined distance from the sensor element, the control apparatus configured to determine a temperature as a function of the temperature of the sensor element, and determine the rotation as a function of the temperature of the control apparatus.
